(19) United States
(12) Patent Application Publication
(10) Pub. No.: US 2002/0069046 A1
(43) Pub. Date: Jun. 6, 2002

(54) Speech communication system

(76) Inventors: Dan Bress, Rockville, MD (US); Steve Bress, Rockville, MD (US); Lorna Brody, New York, NY (US)

Correspondence Address: Evenson, McKeown, Edwards & Lenahan P.L.L.C., Suite 700, 1200 G Street, N.W., Washington, DC, 20005, US

(21) Appl. No.: 09/727,506

(22) Filed: Dec. 4, 2000

(51) Int. Cl. G06F 17/20

(52) U.S. Cl. 704/1

(57) ABSTRACT

A method and system for producing audio speech for a speech-impaired user and/or a user desiring audio speech in a language a user is unfamiliar with. Phrases and sentences are spoken in different voices, converted to Digital Speech Audio Files (DSAF) and stored on a server. These DSAF are then organized into Social Groupings. A user is granted access to this server. These DSAF organized into Social Groupings may also be distributed on physical digital media. A user moves desired DSAF either individually or in Social Groupings onto client machine. If a user requires phrases or sentences not offered, a request is issued, and subsequently the requested phrases or sentences are distributed to user and moved to client machine. A user organizes the DSAF on the client machine by modifying existing Social Groupings, creating new Social Groupings and/or assigning a unique code to selected phrases and sentences. The DSAF arranged in Social Groupings are moved to a portable device, if not already on one. A user identifies and plays the DSAF as desired to produce speech.

### FIELD OF THE INVENTION

This invention relates to a system for producing customizable speech for use by a person wishing to use such speech to communicate with others. The spoken words may be in any language and the person may be one who does not speak the spoken language or be speech impaired. The spoken language is fully customizable for the user.

### BACKGROUND OF THE INVENTION

1. Portable Artificial Speech Systems (PASS) Overview

Speech is the fastest method of casual communication, among hearing people. It is obvious that individuals lacking the ability to speak, whether due to being speech-impaired and/or lacking knowledge of a desired language, would desire a portable device to enable them to communicate by spoken word. Unfortunately, current art does not support a perfect Portable Artificial Speech System (PASS). Therefore, current art devices involve various compromises, that are strong in some areas and weak in others. Portable Artificial Speech Systems current art is summed up as follows:

1. Input Source Language.

2. Apply Computer Processing and/or Artificial Intelligence (AI).

3. Output Target Language.

### PRIOR ART RELATING TO INPUT DEVICES

Input devices include: standard keyboards; Multi-use keyboards (Mikulsi 4,503,426) (Baker 5,299,125), Buttons (Maruta 5,523,943; 5,530,644; 5,606,498; 5,868,576) (Seno, 5,991,711) (Kind 5,275,818); Touchpad (Little 4,908,845); Tablet (Takeuchi 5,875,421), (Forest 6,005,549); Iconic Graphical User Interface (Steele 5,169,342); Single Switch (5,047,953); Sign Language Gloves (Sakiyama 5,659,764; 5,953,693); and even Speech (Rondel 4,984,177) (Alshawi 5,870,706). Also included in Input Devices would be methods to speed input such as (Ichbiah 5,623,406) system to speed keyboard entry through the use of custom defined abbreviations. The use of these different devices involve various trade-offs. For example, a standard keyboard is perhaps the slowest input device, but is also the most accurate. Speech Input requires a very high level of complexity to translate the source language, with a decrease in accuracy, but is (in theory) easy to use. Button input is generally desired for small devices. Single switch input is vital for individuals with serious physical impairments, while a Touch Display input is quite useful for individuals with less serious physical impairments.

### PRIOR ART RELATING TO ARTIFICIAL INTELLIGENCE (AI)

The problems of creating artificial speech are compounded by the complexity of speech itself; the added meaning which comes from intonation and body language; differences in grammar and inflection between different languages; and finally language that is dependent on social environment. The purpose of the AI is to take the source language input and prepare it for output in the target language. There are many different methods to accomplish this. The simplest breaks Source Language into words then translates it through use of a dictionary, word by word. Doi (4,791,587) improves on this method by submitting homonyms for user intervention. Hutchins (4,994,966) does grammar checking on Source Language to ensure greater accuracy of translation. Kaji (5,020,021) examines Source Language for missing elements, such as pronouns. Fukumochi (5,321,607) uses parsing trees on the Source Language, identifies phrases with possible multiple meanings, and refers same to user. Tolin (4,864,503 and 5,490,061) translates the Source Language to Esperanto and then to Target Language. Stentiford (5,384,701 and 5,765,131) searches Source Language for keywords that correspond to a stored phrase. Maruta (5,523,943 etc.) uses phrase matching, where a user is presented a limited number of phrases in a source language that are matched with phrases in the target language. Kanno (5,406,480) builds and analyzes co-occurrences. Kaplan (5,523,946 and 5,787,386) translate the Source Language into a Pivot Language and thence to the Target Language, reducing computer resource required to translate to multiple languages. Kutsumi (5,826,219) is able to reduce compound sentences in Source Language to simpler phrases allowing more accurate translation. Kawamura (6,009,443) identifies and displays conjugation combinations of person and tense. Suda (6,023,669) bases translation of Source Language on the social situation Target Language is to be used. Takeuchi (5,875,421) uses a query system wherein a user enters a desire such as “I am thirsty” and the device queries user about particulars to guide user to a particular stored phrase in Target Language.

### PRIOR ART RELATING TO OUTPUT DEVICES

The object of an output device is to provide as natural speech as possible. The simplest device is a voice synthesizer that is given the Target Language one phoneme at a time, and speaks one phoneme at a time (as opposed to entire words). The output from this method is very artificial. The step up is a Word Matching system, where the voice synthesizer is given the Target Language one word at a time. This is an improvement, but the words are spoken which equal pauses between them, which still sounds artificial. Additionally, by speaking one word at a time, most emotional content is lost, creating artificially sounding speech. Phrase matching devices may send entire phrases to a voice synthesizer, resulting in less artificial sounding speech. Seno (5,991,711) is a combination of phrase matching with phonemes. This allows it to smoothly say “I live at” and then ‘sound out’ the address using phonemes. Joyce (4,908,845) requires the user to acquire, edit and digitize phrases. Kind (5,275,818) provides the user phonemic pronunciation of Target Language for user to speak. Engelke (5,974,116) relies on a live interpreter.

### DESIRED QUALITIES OF A PORTABLE ARTIFICIAL SPEECH SYSTEM (PASS)

To date it has not been possible to make a perfect Portable Artificial Speech System (PASS). All current systems include certain trade-offs. The perfect PASS would be; Accurate (technical, syntactic), Affordable, Responsive, Customizable (contents, interface, output), Upgradeable, Easy to Use, and provide Feedback to the user. Below is a discussion of how various trade-offs affect these qualities.

A. Accuracy

There are two types of Accuracy to be considered; Technical and Syntactic. Technical Accuracy refers to how accurately the Source Language is translated into the Target Language. For example, Source “My dog I love” is translated into Target as “My dog I love.” Syntactic Accuracy refers to how accurately the translation follows the Target Language's syntactic rules. For example, the Source “My dog I love” with English as the target, would be more Syntactically Accurate if translated as “I love my dog.”

Technical Accuracy begins with accurate input. A positive input device, such as a button or keyboard is more accurate that a translated input, such as from a Speech Recognition System. A button system such as Maruta (5,523,932 etc.) leaves very little room for inaccuracies. A system using a keyboard is more flexible than a button system but is open to misspellings in the Source language input and thus generating an incorrect translation. A speech recognition system, such as Alshawi (5,870,706) is easy to use and very flexible, yet being a more complex system is more likely to produce inaccurate input, thus leading to inaccurate translation.

The most Technically Accurate Artificial Intelligence (AI) system is one that employs phrase matching, such as Maruta (5,523,943 etc.). By the use of matching pairs of phrases (Source and Target) accuracy is ensured. The trade-off with such a system is that the user is limited in both input and output. The user is required to choose only from phrases stored in the system. A system using keywords to stored phrases, such as Stentiford (5,384,701) allows more input flexibility at the expense of accuracy. This type of system does not restrict the user's input. It scans the input for keywords in the source language, which it matches with stored phrases in the target language. The most flexible systems do not use phrase matching. Any user input is allowed (Source) and an attempt is made to accurately translate it. The problems with homonyms (Doi, 4,791,587) and inflection (Kawamura, 6,009,443) alone, illustrate that this flexibility is matched by a decline in accuracy.

Technical Accuracy in Output devices can be assessed by how natural the output speech sounds to a listener in the target language. A phrase system such as Stentiford (5,384,701) is able to produce more natural speech with a trade-off in flexibility. A word-by-word system is more flexible with a corresponding trade-off in how natural it sounds.

There are a number of systems described in the art that provide grammatical accuracy of translations. They can be broadly categorized by whether they employ Phrase Matching or not. A Phrase Matching system stores a complete phrase in the Target Language to ensure accuracy. The only source of inaccuracy would be if multiple phrases are combined in an incorrect manner. The phrase matching system trades off flexibility for accuracy. A non-phrase-matching system is obviously less accurate but more flexible.

B. Affordability

When reviewing current art it becomes obvious that various systems involve trade-offs between flexibility and affordability. For example, Engelke (5,974,116) requires use of a mobile phone plus a live human translator, obviously very flexible but also costly and likely not always conveniently available. A device such as Takeuchi (5,875,421) is designed to be affordable but it is not very flexible. AI systems trade-off system requirements (hardware on which the AI runs) and affordability. Systems such as Suda (6,023,669) are high on system requirements and thus less affordable, but provide better translations, than less system intensive systems.

C. Responsive

For purposes of this discussion responsive refers to Lag Time. Lag Time is the time period from when a user determines (in their mind) a desired phrase to be spoken and when that phrase is actually spoken. Lag Time in a known language would be 0. An example may be helpful here. John is in an airplane and does not speak the language of the flight attendants. A flight attendant brings John a drink. Upon examining his drink John determines he would like extra ice. Lag time is measured from when John determines he would like extra ice and when his Portable Artificial Speech System speaks. Every system will have different lag times depending on the particular situation. A system such as Takeuchi (5,875,421) is designed for use by casual travelers, and so will have a very small lag time, but sacrifices flexibility for this. A speech recognition system which requires the user to validate the input, trades-off ease of use and flexibility for an increase in lag time.

D. Customizable

Three areas of Portable Artificial Speech Systems can be customized; the input device, the AI, and the output. Ichibiah (5,623,406) is a system which customizes keyboard input through the use of custom abbreviations. Seno (5,991,711) is an example of AI customization. It allows a user to enter a custom noun in selected phrases. Ideally the voice spoken by the Portable Artificial Speech System should match the user's own voice or for a speech-impaired user, a voice that matches a user's expected voice (male/female deep/high).

E. Upgradeable

Language changes constantly. Especially in technical fields, language changes very quickly. Just a few years ago terms such as, “email”, “dot com” and “world wide web” were not in common use. Currently, any PASS used for business communication would be considered defective if it could not deal with these terms. A device such as Maruta (5,530,644) which limits its scope to the casual needs of tourists does not require upgradeability, as a tourist's general needs do not change. However, a more universal phrase matching system would need to be upgradeable. A system that can output words phonetically is less concerned with upgradeability than a system which requires a complete word.

F. Ease of Use

All Portable Artificial Speech Systems work well in a controlled environment, such as a business office or hotel room. Not all PASS work equally well in day to day environments such as in the back of a taxi, or at a streetside vendor. Devices which use keyboards are not as easy to use as devices which use buttons or devices which use speech input.

G. Operating Feedback

Ideally the PASS should provide the user with adequate visual feedback that it is operating properly, keeping in mind that a user will not understand and/or through impairment hear the target language spoken.

### THE FAST FOOD RESTAURANT TEST

It can be seen from the foregoing discussion that there are no perfect Portable Artificial Speech Systems. They all have different functionality, and are useful in certain situations. However, they all fail the Fast Food Restaurant Test.

The Fast Food Restaurant Test assumes a user knows at the beginning of the day that s/he is going to lunch with a group of people. The group could have gone to any number of restaurants, but voted to go to McDonalds®. Upon studying the menu a user decides s/he desires a Big Mac® Meal, supersized, and hold the pickles. Some of the PASS could not form this speech, while others would require an unacceptable lag time.

### THE TAKE ME OUT TO THE BALLPARK TEST

This test assumes a user is in a hotel and desires to go to a Baseball Game and return to the hotel. In order to accomplish this, a user will need to have a number of casual conversations. To fellow elevator passenger—“press lobby please”. To doorman—“cab please”. To cab driver—“take me to Riverfront Stadium”. To food vendor—“I would like one chili dog and a beer.” To vendor—“I would like this T-shirt”. To ballplayer—“would you autograph this please”. To seat neighbor—“can I get you anything?” To fellow fan—“pardon me—coming through” To cab driver—“Ramada Hotel, on Elm” To fellow elevator passenger—“press 12 please.” Some of the known PASS could not form this speech, while others would require an unacceptable lag time. Keyboard based systems would be hard to use in these various and often crowded environments.

The present invention has passed these tests by combining the internet, portable computing devices such as PDAs (Personal Digital Assistants) and the availability of cheap memory.

### SUMMARY OF THE INVENTION

The present invention has as a first objective (a) creating and storing a large number of Digital Speech Audio Files (DSAF) where each DSAF contains a commonly used phrase (b) creating a description of each phrase in one language, although the phrase may be in a second language (c) and providing means to distribute these phrases through electronic and/or physical media.

A second object of the invention is to provide a means of classifying these phrases into various conversational groupings along with a method for identifying and retrieving various conversational groups and subsets.

A third object of the invention is a method for a user to easily edit these conversational groups and/or create custom conversational groups.

A fourth object of this invention is a method for a user to assign a custom code to a particular phrase for rapid retrieval.

A fifth object of this invention is a method for a user to request and retrieve a custom phrase in a timely manner.

A sixth object of this invention is a method for rapid identification of required phrases in most real world environments.

A seventh object of this invention is a method for speaking phrases in most real world environments.

Thus the present invention provides a method for producing customizable audio speech for use by a person wishing to use such speech to communicate with others, which comprises the steps of

a) creating a plurality of sets and sub-sets of words, phrases and sentences in text form in a source language;

b) creating a plurality of sets and sub-sets of digital speech audio files corresponding to words, phrases and sentences in one or more target languages in different voices, by recording the voices speaking the words, phrases and sentences in the one or more target languages;

c) associating each of the words, phrases and sentences in text form in the source language with one or more of the digital speech audio files, in the one or more target languages so that selection of the text form in the source language allows retrieval of the corresponding digital speech audio file in the one or more target languages in a specific voice and storing said associated sets in a central open server in digitized electronic form in a database;

d) organizing said words, phrases and sentences in text form in the source language into conversational social groups and subgroups;

e) coding said words, phrases and sentences, and said conversational social groups and subgroups to allow for rapid retrieval and for customization of same into personal groups and subgroups;

f) means for communicating requests to the central open server for additional words, phrases and sentences in text in source language to be created in additional digital audio files in one or more target languages in one or more voices; which may form part of existing or new conversational social groups and subgroups;

g) creating said additional digital audio files on a closed server for access by the requester only;

h) means for a requester to alter and create new conversational social groups and subgroups;

i) means for playing said selected digital audio speech files so that a user may use such words, phrases and sentences to communicate by speech with others in a selected target language; and

j) means for graphically displaying one or more selected digital audio speech files to verify what is being spoken to the user.

### BRIEF DESCRIPTION OF THE DRAWINGS

The accompanying drawings are used to illustrate the present invention.

FIG. 1 is a block diagram illustrating the general concept of the present invention;

FIG. 2 is a block diagram illustrating an embodiment of the present invention where a modem equipped Personal Digital Assistant uses a Personal PC as a server;

FIG. 3. is an illustration of server side conversational groupings;

FIG. 4. is an illustration of server side conversational groupings;

FIG. 5. is an illustration of a user modified conversational grouping;

FIG. 6. is an illustration of a user modified conversational grouping with custom phrases;

FIG. 7. is an illustration of a user made custom conversational grouping;

FIG. 8. is an illustration of a user defined custom coding of individual phrases;

FIG. 9 is a flow diagram illustrating an embodiment of the present invention;

FIG. 10 is an illustration of a sample user interface;

FIG. 11 is an illustration of how a database for the invention is constructed; and

FIG. 12 is another illustration of how a database for the invention is constructed.

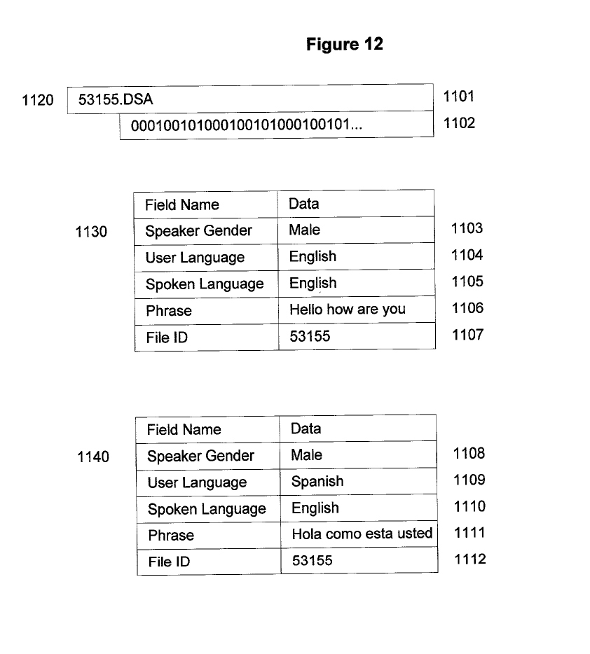

### DETAILED DESCRIPTION OF THE PREFERRED EMBODIMENTS

1. Overview

The preferred embodiments of the present invention will be described with reference to the accompanying drawings.

This invention allows a user to rapidly select and produce artificial speech in an unknown and/or unspeakable language. This invention addresses the problems of speech-impaired users as well as users desiring to speak an unknown language, such as an English speaker wishing to speak Spanish. To provide a more clear example for the reader, this discussion is restricted to a speech impaired user, although the invention is not limited to such an embodiment. In the following discussion, phrase and Digital Speech Audio File will be used interchangeably. It should also be understood that each spoken phrase is associated with a text description. Therefore a single Digital Speech Audio File might be associated with many different source text descriptions, using industry standard computer databases and interfaces. So for the purposes of this discussion, phrase will mean a Digital Speech Audio File in a target language and a text description in a source language.

In another embodiment of the invention, Digitial Speech Audio Files can be associated with icons and/or a text description.

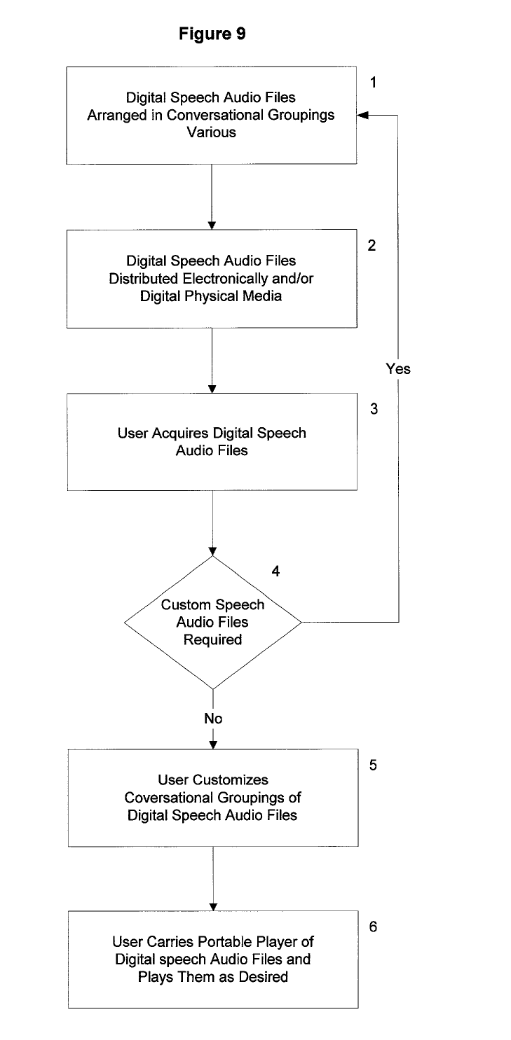

FIG. 9 is a block diagram of the preferred embodiment of the present invention. 1 Digital Speech Audio Files (DSAF) are created and arranged by source language, target language, voice and conversational groupings. Source Language is a language known to the user. Target Language is the language the user desires to speak in. Voice refers to the qualities of the desired speaking voice, male or female, deep or high, etc. Conversational Groupings refers to organizing phrases in such a manner that phrases that would be used in a particular social situation and/or conversation are kept together for fast identification and retrieval. We will go into more detail of Conversational Groupings later.

In a preferred embodiment of this invention these Digital Speech Audio Files are created from human speech, however this invention is not limited to that form of the invention. Computer generated speech may be substituted for Human speech. This computer generated speech would be checked for accuracy, before becoming a Digital Speech Audio File.

It is anticipated that DSAFs will continuously be created, whether due to (but not limited to) user requests, language changes, fast food menu changes, etc. It is also anticipated that some users would have an onerous burden to electronically acquire all DSAFs that they desire. Therefore 2 these Digital Speech Audio Files are available either through electronic or physical digital media.

The user identifies desired phrases and moves them to a computer 3. For ease of discussion it may be referred to as a home computer. For the preferred embodiment this would be any computer capable of running Microsoft Windows 95® or higher software. If a user requires a custom phrase s/he sends a request to a system operator 4.

Once a user has the desired phrases on a home computer, a user is able to edit existing conversational groupings of phrases, create new conversational groupings and/or assign a custom code to a particular phrase 5. Creating custom conversational groupings is made easy enough that users will be comfortable creating new ones each day, if desired.

Next the user moves the desired phrases in their conversational groupings to a portable computer such as a Pocket PC. The user is able to select various conversational groupings, using a point and click method, and quickly find the desired phrase in such groupings. The Pocket PC would then cause that phrase to be played through its speaker or through an external speaker if greater volume is required 6. Alternatively, a user could enter a short memorized custom code which would cause the playing of a particular phrase.

This is a dynamic customizable system. It is technically and grammatically accurate, as all phrases in the target language are recorded. It is affordable as it has low hardware requirements. It is responsive. A user trades-off some preparation time and is rewarded with very little lag time during conversations. It is customizable. A user can create or acquire different looks (skins) for the user interface of the portable computer. A user can choose between different voices. A user can acquire custom phrases. The system is upgradeable. New phrases can be added and/or new conversational groups created, all of which will be available to users. The system is easy to use. Due to its small size and point and click interface, the system is as easy to use in the back of a cab as it is in a hotel room. Finally, the system will graphically display what phrase it is speaking and that it is functioning correctly.

### DETAILED DESCRIPTION

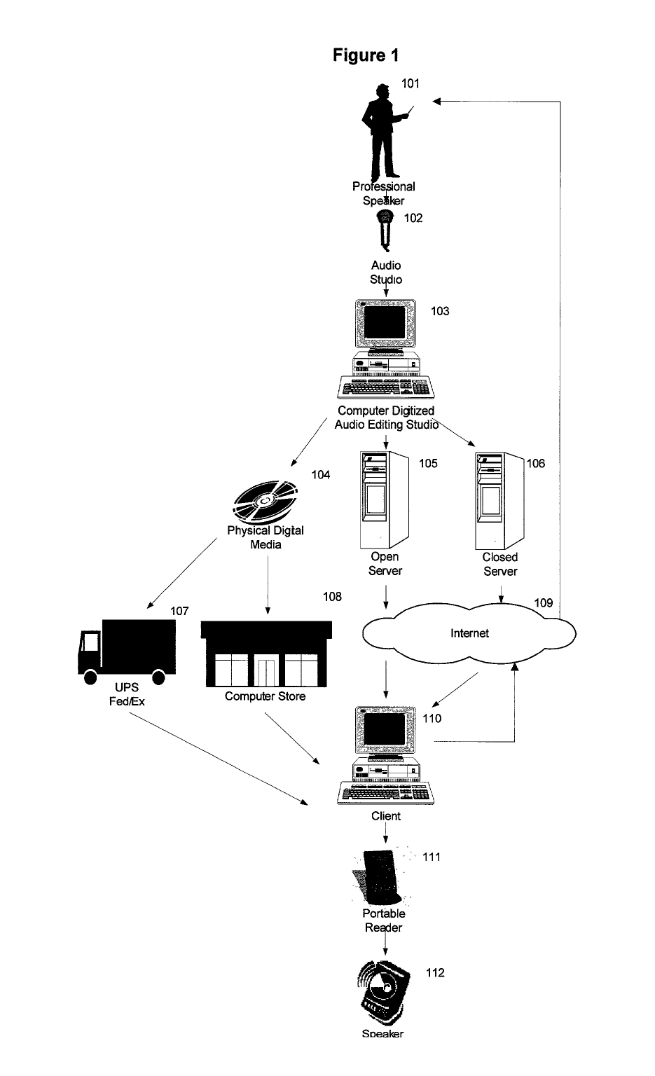

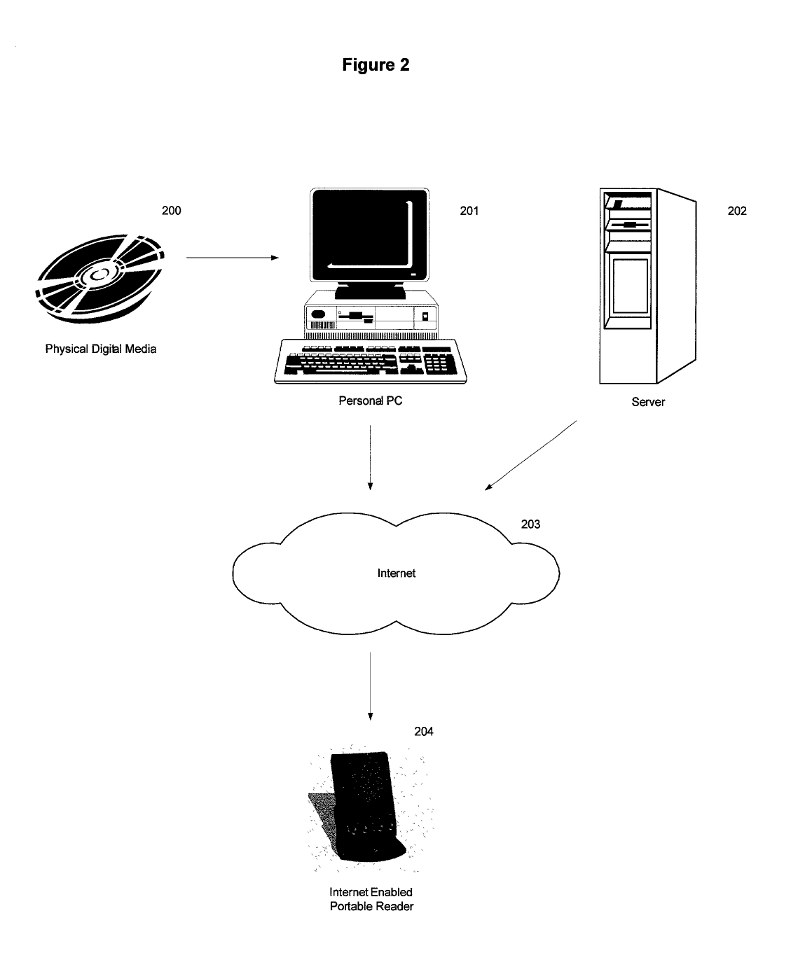

A more detailed description of the preferred embodiment will now be described with reference to FIGS. 1 and 2.

A professional speaker 101 is used to create spoken phrases. We define ourselves to the outside world in a number of ways. One of these is clothes. We would not go to a bank for a house loan in a torn t-shirt and shorts. In the same fashion, we would not want to face the world with an inappropriate voice, therefore the use of professional speakers is necessary. Additionally, voice consistency is a desired quality for a Portable Artificial Speech System (PASS). A professional would be more likely to produce consistent speech, even with recording sessions separated by a large amount of time. Finally, speech-impaired individuals have the same sense of humor that speaking individuals do. Therefore this system is able to offer the user celebrity catch phrases, for example Arnold Schwarzenegger saying “I'll be back,” or Bugs Bunny saying “What's up Doc?”. To ensure high quality sound reproduction an audio studio is used to record spoken phrases 102.

These spoken phrases are recorded, digitized and edited in a state-of-the-art, off-the-shelf system 103. Each spoken phrase is edited to reduce unwanted noise and to produce an appropriate null pause before and after each phrase. Each spoken phrase is compressed, to reduce storage requirements. Each spoken phrase is then associated with a text description in a source language, using industry standard computer databases and interfaces. These phrases are then placed in appropriate conversational groups (discussed below).

These phrases are then placed on a server 105. This is described as an open server, as all users will have access to all phrases on this server. Some users will desire custom phrases, such as their name and address, the name and address of a hotel they are staying at, etc. These phrases will be placed on a closed server 106, with user access granted only to his/her own phrases. One skilled in the art would appreciate that these custom phrases could also be delivered by internet e-mail, other systems of electronic delivery and/or by physical media.

With current art, most users would have an onerous time electronically downloading large numbers of phrases. Therefore, periodically phrases will be placed on physical digital media 104, such as CD-Roms and DVD-Roms for distribution to users, either through delivery servers 107 or through retail establishments 108. Users will use the Internet 109 and/or other means of electronic delivery such as direct dial-up, email, etc. to acquire phrases, either individually or in conversational groupings, from the servers. Users will also be able to send requests for custom phrases.

A client or home computer 110 is used to edit and create new custom conversational groupings as desired. This is done using supplied software, using industry standard computer databases and interfaces. In the preferred embodiment this is shown on a home computer capable of running Windows 95 or higher. One skilled in the art would appreciate that other graphical user interface systems such as Mac or Linux could be used. Additionally, as portable computers become more powerful, some or all functions currently shown on a home computer could be performed on a portable computer. Custom codes can be associated with individual phrases as well.

This information is then moved to a portable device such as a Pocket PC®. One skilled in the art would appreciate that there are many such devices that could be used. There currently exists a number of these devices to choose between, and to a certain extent, the device chosen is just personal preference. A larger device, such as a Handheld PC could be used, but its larger size would make it harder to use in some environments. Our preferred embodiment requires a Windows CE capable device that includes audio player means. One skilled in the art would appreciate that other operating systems could be substituted.

Pocket PCs may currently have up to 320 MB added to them. http://www.iis.thg.de/amm/techinf/layer3/index.html shows audio compression rates using MPEG Layer-3 compression, which would be used in a preferred embodiment of the invention. Analyzing the chart, we see that we get 9 minutes of speech per Megabyte with FM radio quality output or 1 minute of speech per Megabyte with CD quality output. Currently Pocket PCs are available with 320 MB plus of storage, allowing the user to carry hours of speech. One skilled in the art would appreciate that other audio compression besides MPEG Layer-3 this could be used.

Pocket PCs come equipped with an MPEG audio reader and an internal speaker. They also come equipped with an audio output to attach an external speaker, if more volume is required.

Physical digital media such as CD-Roms and DVD-Roms are unable to be read with current art small portable computers. FIG. 2 shows the added flexibility available with a Portable Device equipped with a modem 204. Pocket PCs may be equipped with modems. The Pocket PC, using the Internet or other means of electronic delivery, is then capable of using the home computer 201 along with previously delivered digital physical media 200 as well as the system's servers 202 to download additional phrases while in the field.

Conversational Groups

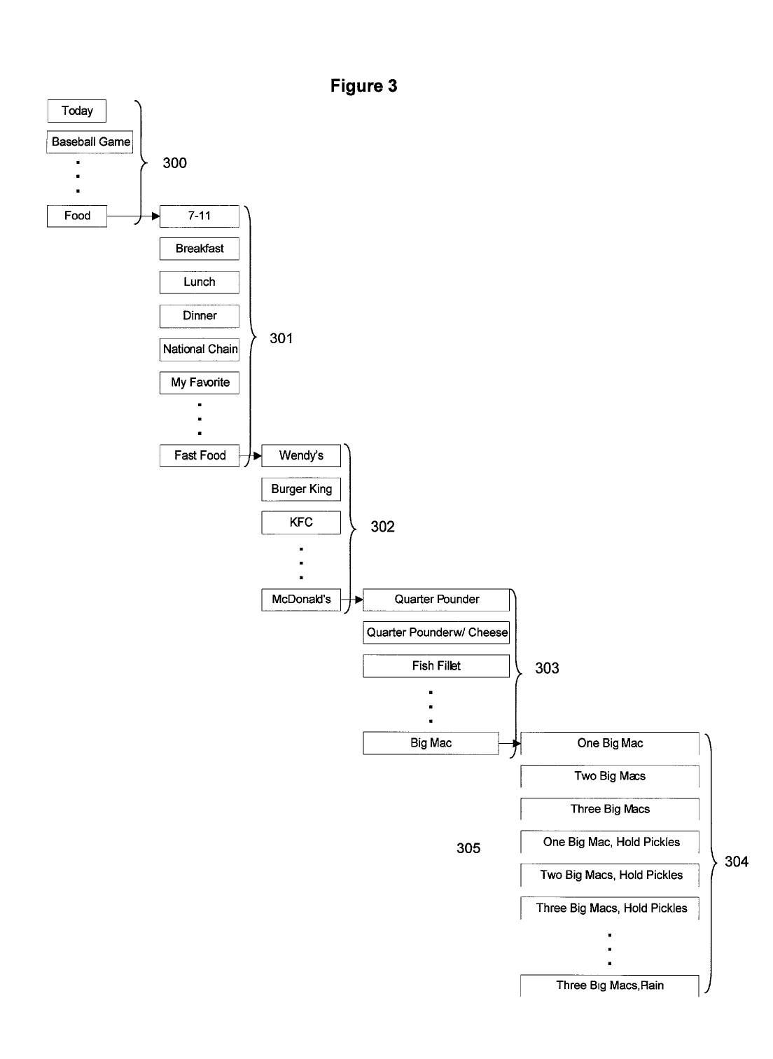

Conversational Groups will be described with reference to the accompanying drawings, FIGS. 3-7.

Without a method of organizing, the thousands of phrases available for quick retrieval, would be useless. For the purposes of this discussion, a phrase is defined as a Digital Speech Audio File in the Target Language associated with a text file description in the Source Language. For the purposes of quick retrieval, available phrases are organized and grouped according to various social situations. Social situations are as diverse as ordering food at a fast food restaurant and going to a ballpark. By predicting what phrases are appropriate in various social situations and grouping them in Conversational Groups, a user is able to quickly retrieve desired phrases.

FIG. 3 shows one embodiment of conversational groupings before the user has customized them. The broadest groupings are the highest 300. Each successive level narrows the groups 300 through 303. Until at the lowest level 304, text description of the phrases is shown. On a portable device (such as a PDA) a user carries, this text would be displayed in an industry standard interface. A user would access each level by an industry standard method such as pointing and clicking. So, we can see that a user is just five point and clicks away from having the portable device speak a phrase in the target language. The user points and clicks on Food from group 300 which then displays group 301. Pointing and clicking on Fast Food from group 301 displays group 302, which is a list of fast food restaurants. Pointing and clicking on McDonald's from group 302, displays a list of menu items available from McDonald's 303. Pointing and clicking on a menu item in group 303 displays various phrases, containing various options for that menu item 304. Pointing and clicking on One Big Mac® 305, would have the device speak “I would like to order one Big Mac®, hold the pickles please.”

The text file shown here 305, is smaller than the actual phrase spoken in the target language. This is to make use of the limited viewing area of a portable device and also to assist user retrieval. This text file is modifiable by a user.

These groupings are customizable at any level. For example if a user never intends to go to a Burger King® s/he can eliminate the Burger Kings® group entirely. Another example would be if a user always orders a Big Mac® with everything, s/he can eliminate any phrases modifying Big Macs®.

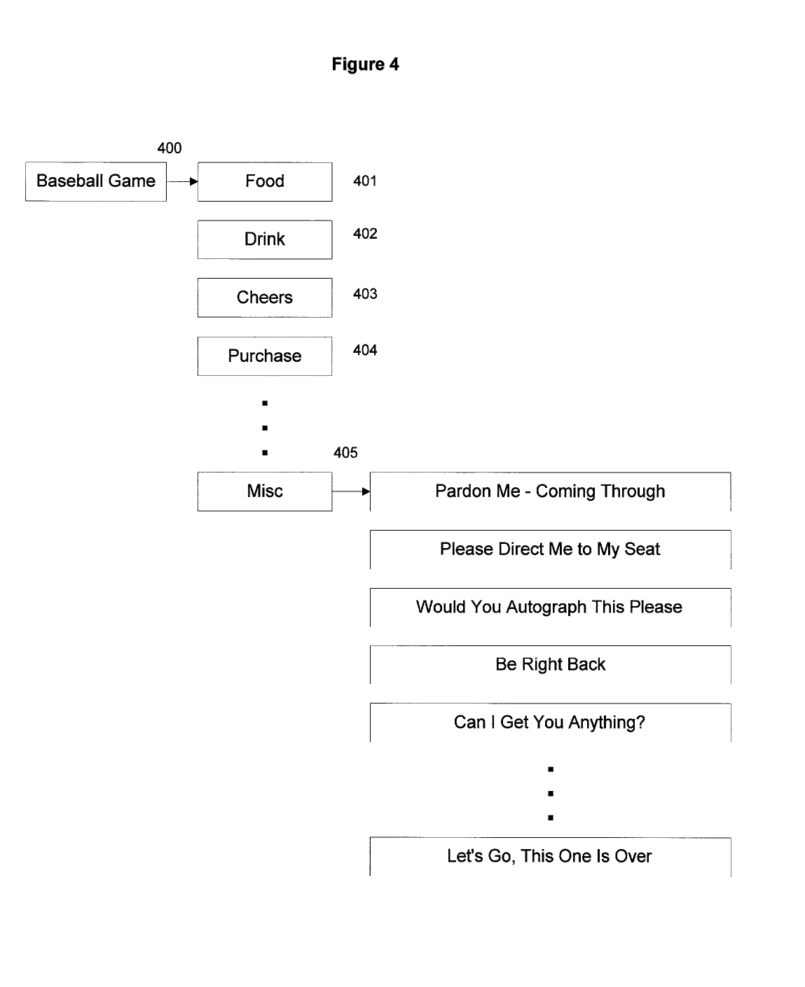

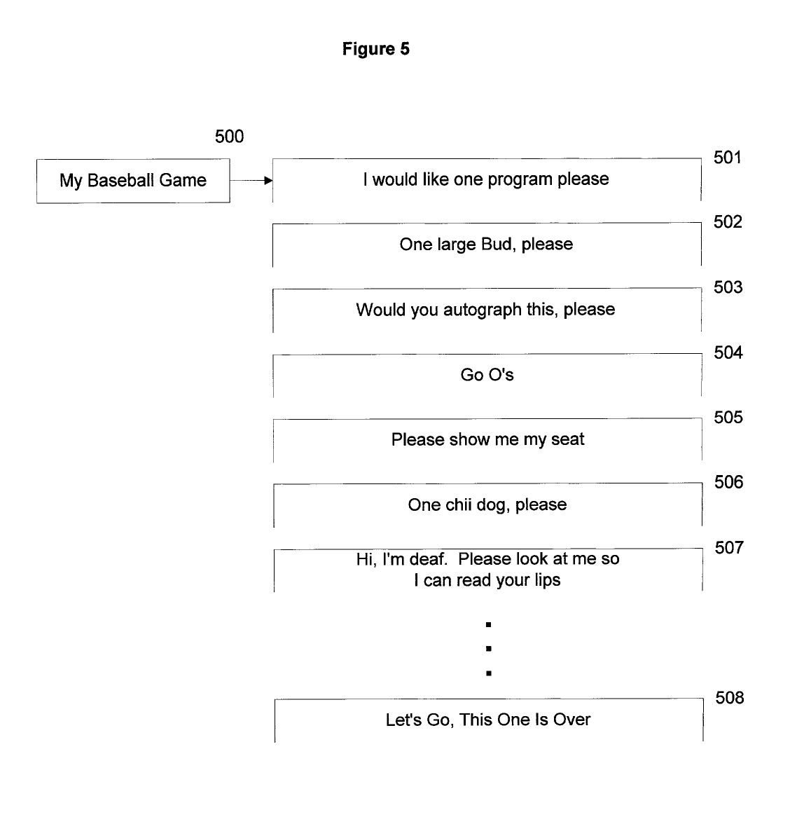

FIG. 4 illustrates a Conversational Group for going to a Baseball Game before user modification. FIG. 5 shows a custom Conversational Group. In this example a user determined what phrases s/he would be likely to speak during a particular baseball game. A user then chooses phrases from different conversational groupings and places them in a new conversational group. In this fashion a user is able to reduce lag time while at the game.

A user creates a new Conversational Group 500 and calls it My Baseball Game. Phrase 501 is retrieved from group 404. Phrase 502 is retrieved from 402. Phrase 503 is retrieved from 405. Phrase 504 is retrieved from 403, and so on. A user may have both the Baseball Game 400 group as well as the My Baseball Game 500 group on his/her portable device for greater flexibility.

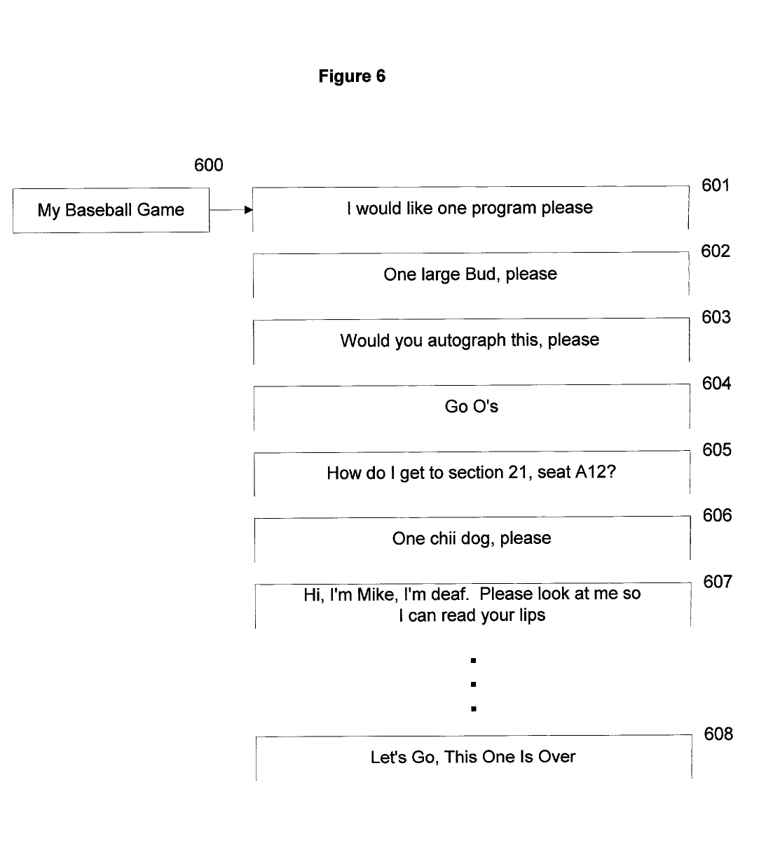

FIG. 6 illustrates a custom Conversational Group 600 with the addition of custom phrases 605 and 607. 607 is an example of a phrase that a user would acquire when first using the system, and subsequently add to many conversational groups. 605 is an example of a custom phrase for one time use.

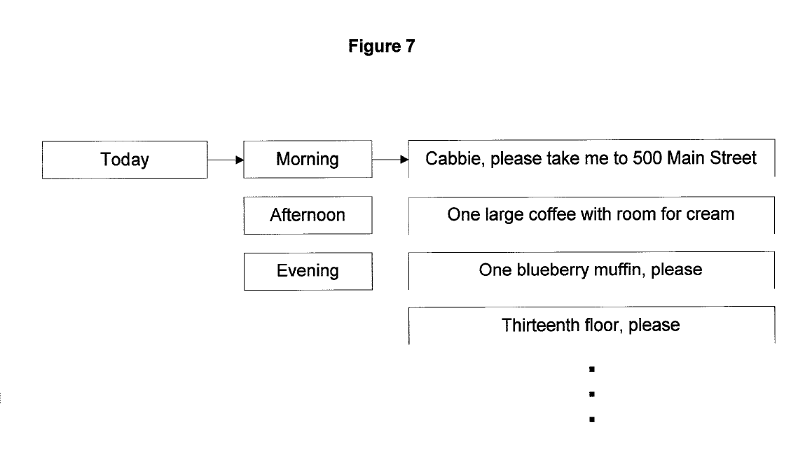

FIG. 7 illustrates an example of a Custom Conversational Group that a user may use in his/her normal routine. By predicting what phrases the user will want during the day and arranging them in Conversational Groupings, the user is able to quickly find desired phrases, thereby reducing conversational lag.

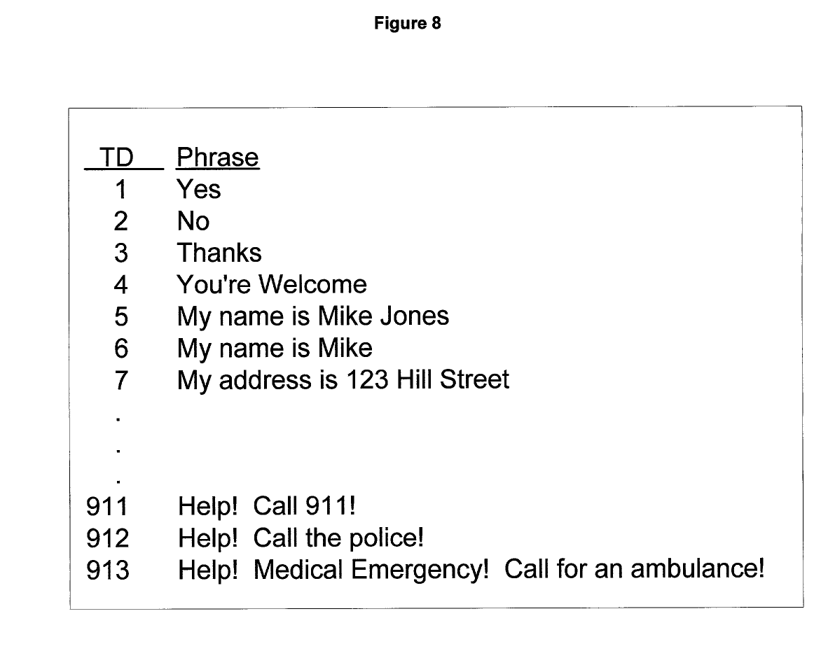

In addition to using an industry standard interface such as pointing and clicking, to navigate Conversational Groups, users will also be able to assign a custom ID to a particular phrase. FIG. 8 shows an example of custom ID and their related phrase. The use of custom phrases allows Conversational Groups to be smaller, as commonly used phrases such as “Yes” and “No” can be retrieved by inputting a small custom ID, using a standard industry graphical interface.

In another embodiment the user interface would include both text descriptions and icons.

Digital Speech Audio Files

Digital Speech Audio Files are those files which, when played by appropriate software, cause a speaker attached to the computer to “speak” a particular phrase or sentence. Just as an audio CD-Rom is divided into songs, which may be played individually or in any order, Digital Speech Audio Files are phrases, which may be played individually or in any order.

These Digital Speech Audio Files will be organized into Conversational Groupings. Conversational Groupings are unique to our invention. It is a method of organizing phrases in a manner that is easy, fast and convenient for a user to find a particular phrase. Conversational Groupings are discussed in detail elsewhere.

This discussion will concentrate on how these phrases are technically organized on a computer. This is done by using industry standard methods and is not unique to this invention. For the sake of clarity we will discuss two methods of technically organizing our Digital Speech Audio Files, but our invention is not limited to these two. One method is based on directories/file names. The other is based on a database system.

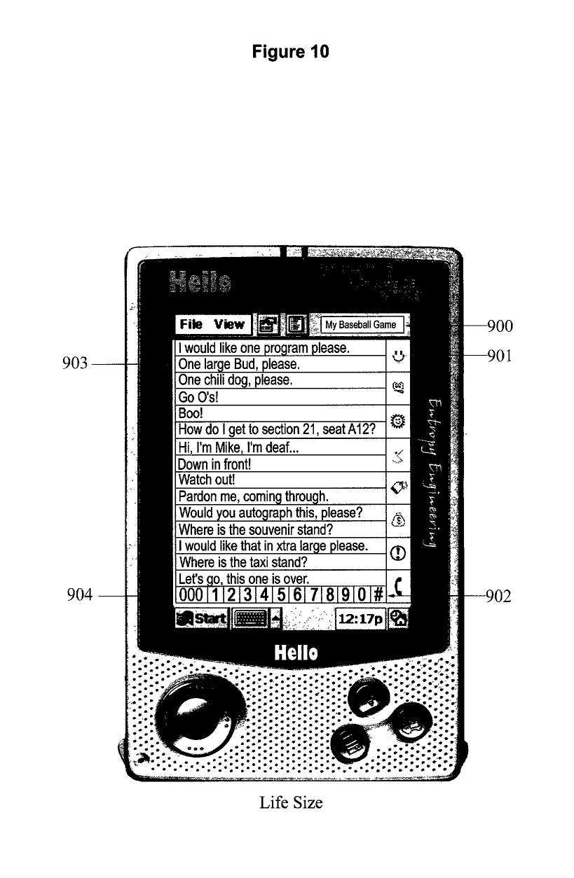

Referring now to FIG. 10, a Digital Speech Audio File, like all files, has two parts, a file name 1001 and digital data 1002. In a Digital Speech Audio File the digital data consists of audio speech that has been digitized to store on a computer, and which can be played by appropriate software to “speak” through a computer's speaker. In our example, the file name “Hello how are you” describes what the digital data will “say” when played out. The last part of the file name is a suffix, which consists of a period followed by three or more characters. In our example, the suffix .dsa identifies the file as digital audio file.

Files are commonly organized into cascading directories. This organization is reflected in the file name by use of a prefix. Each directory name becomes part of the file name prefix, with each level separated by a “\” character. Referring to FIG. 10 again, both 1002 and 1004 have the same data, that is will “speak” the phrase “Hello how are you. Only their file names are different in 1001 and 1003. 1003 describes a phrase that is in a directory of Male's voice, a subdirectory of English as a source language and a further subdirectory of English as a target language. In this example, the first directory holds all phrases which are spoken in a male voice. The second directory holds a subset of male voices with English as the source language. The third directory holds a subset of the second directory with English as the target language. Thus, we know from file name 1003 that when played, the file will speak “Hello how are you” in a male voice, in English. We also know that “Hello how are you” will be shown on a user's computer display in the source language, in this case English, as in 1001.

The digital data in 1002, 1004 and 1006 are the same. They all speak the phrase “Hello how are you” when played. The only difference between 1020, 1030 and 1040 is the file name. We know from filename 1005 that the file will speak “Hello how are you” in a male voice, in English. “hola cómo es usted” will be shown on a user's computer display in the source language, in this case Spanish.

We have described two Digital Audio Speech Files that are identical except for their file names, 1030 and 1040. This is wasteful of computer storage space, as the digitized speech component 1004 and 1006 is repeated. A more efficient way to store these Digital Audio Speech Files is by using a database system, which will be described next.

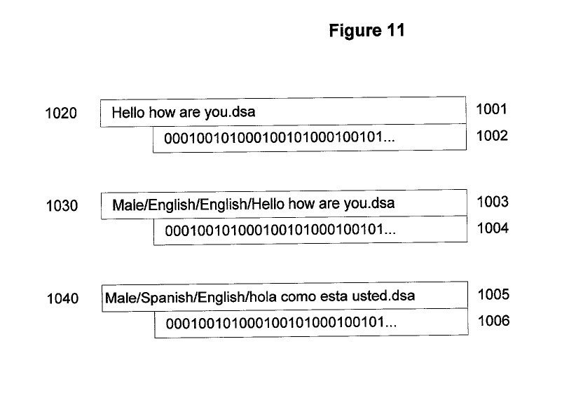

Referring now to FIG. 11, a database system is a way around the necessity of having to store duplicate data, as in the example discussed above. In a database system, the digitized audio speech 1102 is given a sequential number, 1101. The information that had been contained in the file name is now contained in a look up table, or database record, 1130, 1140. Database records are divided into pieces of information called fields. You will see that database record 1130 has the same information as in the filename of 1030. Database record 1140 has the same information as in the filename of 1040. The difference between the two systems is that the database record has a field 1107 and 1112 that references the digitized audio speech 1120.

The user interface, which is discussed elsewhere, takes information from either the filename or from a database record and displays that information in a way that it is easy, fast and convenient for a user to choose a required phrase. The important point is that there is information associated with each digitized audio speech. This information includes such items such as type of voice, target language, a text description in a source language, etc.

Following is an example of the use of the invention. In this Example Mary, a first-time user, speech-impaired individual uses the present invention. The following example is for illustrative purposes only and is not meant to limit our invention to these particulars.

Mary, A Speech-impaired, First-time User

Mary is speech-impaired. She owns a personal computer (PC) that runs Windows 95®, has a CD player and a modem. Mary has her PC connected to the Internet. She also has a Pocket PC®, which has an internal speaker and a method of connecting to her PC. Mary decides she wants to use our invention, so she goes to her local computer store and purchases a retail version, which comes in a box. When she gets home she opens the box to find a reference manual and a CD. She puts the CD into her computer and runs the installation program.

When the program is first run it collects information to build a user profile. Mary is asked to fill out the following information:

First Name?

Middle Name?

Last Name?

Nickname?

Prefix (r./Miss./Mrs./etc.)?

Home Street Address?

Home City/State/Zip?

Home phone number?

Home email address?

Home TTY number?

Source Language (What language do you want text to be)?

What voice do you want to speak?

Female/Soprano

Female/Mezzo Soprano

Female/Alto

Female/Contralto

Etc.

Work Street Address?

Work City/State/Zip?

Work phone number?

Work email address?

Work TTY number?

Password?

Etc.

The software of the invention then asks Mary to connect to the Internet. Once this is done, her User Profile is uploaded to a central server. Mary is informed that her custom phrases will be available in two to three days and she will be notified by email when they are ready to be downloaded. After Mary receives notification that her custom phrases are ready, she connects to the central server and downloads her custom phrases. As discussed elsewhere, natural speech is spoken in complete phrases. Although individual phrases could be combined together, it would not produce high quality speech, therefore Mary is given a number of similar phrases. She receives a Conversational Grouping titled Mary's Personal Information that contains the following phrases:

Mary's Personal Information

Name

Mary

Alice

Smith

Mar

Mary Smith

Mary Alice Smith

Miss. Smith

Miss. Mary Smith

Miss. Mary Alice Smith

My name is Mary.

My name is Alice.

My name is Mary Smith.

My name is Mary Alice Smith.

My name is Miss. Mary Smith.

My name is Miss. Mary Alice Smith.

Just call me Mar.

My friends call me Mar.

You can call me Mar.

Hello, my name is Mary.

Hello, my name is Alice.

Hello, my name is Mary Smith.

Hello, my name is Mary Alice Smith.

Hello, my name is Miss. Mary Smith.

Hello, my name is Miss. Mary Alice Smith.

Home

123 Maple Drive

Rockville, Md. 20850

301-555-1212

masmith@isp.com

301-555-1222

123 Maple Drive, Rockville Md. 20850

123 Maple Drive, Rockville

My home address is 123 Maple Drive.

My home address is 123 Maple Drive, Rockville, Md.

My home address is 123 Maple Drive, Rockville, Md. 20850

I'm going to 123 Maple Drive in Rockville

My home phone number is 301-555-1212

My email is masmith@isp.com

My TTY number is 301-555-1222

Work

456 Main Street

Bethesda, Md. 20814

301-555-1223

masmith@work.com

301-555-1224

456 Main Street, Bethesda

456 Main Street, Bethesda, Md. 20814

My work address is 456 Main Street, Bethesda

My work address is 456 Main Street, Bethesda, Md.

My work address is 456 Main Street, Bethesda, Md. 20850

My work phone number is 301-555-1223

My work email is masmith@work.com

My email is masmith@work.com

My work TTY number is 301-555-1224.

Now Mary is ready to use the invention software to customize her Conversational Groups and her User Interface on her Pocket PC. She starts by creating a new Conversational Grouping for Workday Morning. She first creates a new Group that she names Workdays, and then creates three subgroups called Morning, Afternoon, and Evening. At this point the highest level (Top) Conversational Groupings look like this:

Communication

Emergency

Food

Hobbies

Mary's Personal Information

Mary's Workday

Miscellaneous

Social

Sports

Transportation

If Mary were to choose (double-click on) Mary's Workday she would then have these Conversational Groups to pick from:

Morning

Afternoon

Evening

Turning now to Conversational Groupings again, most casual conversational needs can be known in advance. Daily routines are known, plans can be made ahead. An investment in time in planning ahead will save time in picking an appropriate phrase to speak, out in the field. Essentially Conversational Groupings are a series of cascading directories. Just as with Windows® directories, you can move between them with up arrows, back arrows as well as point and clicking. Each directory contains Speech Audio Digital Files that are related in some fashion. The object of this arrangement is to quickly find a required phrase.

Mary starts work on her Workday Morning Conversational Group by noting down what she does on a workday morning. Mary's list looks like this:

Call for cab. Done by using her TTY.

Taking cab to work. Tell cab driver where to go.

Stopping by the Starbucks® next to her office. Ordering coffee and a snack.

Taking elevator to her office.

Etc.

In addition to the list above, Mary wants to add a few other common phrases to these activities that require speech in selected conversational groups. That way, when Mary starts off the day and opens this Conversational Group, most of the phrases that she will need for the morning will be on the display in front of her. (Refer to FIG. 10) This means that some phrases, like “Hello, my name is Mary” may end up in multiple Conversational Groupings. Note, in our example in FIG. 9, there are fifteen lines of displayed text. Mary decides that she will keep her custom Conversational Groupings to fifteen lines and instructs the software of her decision. Mary decides that the first phrase in her Workday Morning Conversational Grouping will be “Hello, I am Mary”. Mary follows these steps:

Starting at the Top Conversational Grouping Mary chooses (double clicks on) Mary's Personal Information

She then chooses Name

She then chooses the phrase “Hello, my name is Mary”

This can be shown in this fashion:

Mary's Personal Information>Name>“Hello, my name is Mary”

For the second phrase of her Conversational grouping she chooses “456 Main Street, Bethesda.”

Mary's Personal Information>Work>“456 Main Street, Bethesda”

Next Mary wants to have phrases ready for her stop at Starbucks®. She connects to the Internet and reaches the program web site. She does this instead of using the program CD, because the most current national restaurant chain menus are available from the website. She starts by choosing Food. This gives her the following choices:

Breakfast

Lunch

Brunch

Dinner

Fast Food

National Chains

Drinks

Etc.

She chooses Drinks, which opens up these choices:

Coffee

Soft Drinks

Juice

Beer

Mixed Drinks

Wine

Etc.

She chooses Coffee, which opens up these choices:

Generic

Seattle's Best®

Starbucks®

Etc.

She chooses Starbucks®, that opens up these choices:

Coffee

Coffee Drinks

Pastry

I want it my way

Etc.

She chooses Coffee, which opens up these choices:

I would like a Venti Coffee please.

I would like a Venti Decaf please.

I would like a Venti Today's Special please.

Etc.

Mary chooses “I would like a Venti Coffee please.” So to sum up, Mary went through cascading Conversational Groups, which can be shown like this:

Food>Drinks>Coffee>Starbucks®>Coffee>“I would like a Venti Coffee please.

Mary always takes cream with her coffee, so she needs to ask them not to fill the cup up.

She backs up a level

Coffee<Starbucks®

And then goes to:

Starbucks>I want it my way>“Please leave a little room for cream”

Mary instructs the software of the invention to link the two phrases she has just shown together, so when she chooses “I would like a Venti Coffee please,” eHello will say right after that, “Please leave a little room for cream.”

In a similar fashion Mary chooses some more phrases for her Workday Morning Conversational Group:

Coffee<Starbucks®>Pastry>“I would like a Low Fat Blueberry Muffin please”

In case they are out of Blueberry Muffins she adds:

“I would like a Low Fat Cranberry-Orange Muffin please.”

There is an elevator between her and her workplace. In case she needs to ask someone to push the button for her floor, she adds:

Transportation>Elevator>“Please press thirteenth floor”

At this point Mary's Workday Morning Conversational looks like this:

Hello, my name is Mary.

456 Main Street, Bethesda

I would like a Venti coffee please. Please leave a little room for cream

I would like a Low Fat Blueberry Muffin please.

I would like a Low Fat Cranberry-Orange Muffin please.

Please press thirteenth floor

In a similar fashion, Mary continues to add to her Workday Morning Conversation Grouping. Mary continues to make her custom Workday Afternoon Conversational Group and Workday Evening Conversational Group. Mary works near a McDonalds® and often goes there for lunch. Since Mary does not know what she might want for lunch, she downloads the complete McDonald® conversational grouping, from the central website.

Food>Fast Food>McDonalds®

In this way Mary has the complete McDonalds® menu available to her. There is a Burger King® around the corner, so Mary downloads the complete Burger King® Conversational Grouping as well. In a similar fashion Mary makes more custom Conversational Groupings and adds pre-made Conversational Groupings. Mary has the option of adding a pre-made Conversational Group and deleting groups she does not want. In our example above of Starbucks®, Mary may have downloaded the entire Starbuck® Conversational Group with the exception of Coffee Drinks, which she does not want.

Mary next starts choosing icons and their related phrases. The software of this invention displays a number of icons for Mary to choose. When she has chosen one, she is asked what phrase to associate with it. She first chooses a Smiley Face 901. She chooses the phrase “Yes” to associate with the icon. She chooses seven more icons, and in a similar fashion, she associates the phrase “No” with the second icon, “Thanks” with the third icon, “You're Welcome” with the fourth, “My name is Miss Mary Alice Smith” with the fifth, “How much is that” with the sixth, “Help, please” with the seventh, and “Help, call 911” with the eighth.

Lastly, Mary associates phrases she will be using often with a three-digit code, as in FIG. 8.

This explanation takes longer to read than it will for a user to do. That is one of the advantages of using a graphical interface; it is faster and easier to use than text. Once Mary has arranged things to her liking, she connects her Pocket PC® to her PC with a standard cable and instructs the main program computer to download her custom Conversational Groupings to her Pocket PC. In this fashion, Mary can quickly and easily modify her Conversational Groups daily if she wants.

The device shown in FIG. 9 is life sized. It weights approximately 8 ounces. It can be carried in a pocket, purse, pouch, or belt holster. Let's follow Mary as she begins her workday.

Before Mary leaves home she turns her Pocket PC® on and starts the software. Her Pocket PC® has a pen-like pointing device, which she uses to point and click to make selections. Mary double clicks on Mary's Workday from the top conversational group and then double clicks on Morning.

Mary's Workday>Morning

That brings the following Conversational Group up on screen:

Hello, my name is Mary.

456 Main Street, Bethesda

I would like a Venti coffee please. Please leave a little room for cream

I would like a Low Fat Blueberry Muffin please.

I would like a Low Fat Cranberry-Orange Muffin please.

Please press thirteenth floor

Etc.

Mary's cab comes. Mary gets in the cab and double clicks on “456 Main Street, Bethesda” and her Pocket PC® speaker speaks in Mary's chosen voice “456 Main Street, Bethesda.” Mary has taken less than two seconds to select the appropriate phrase, since she had taken the time to customize this Conversational Grouping earlier. Next stop is Starbucks®. When it is Mary's turn in line, she is ready. She has already highlighted “I would like a Venti Coffee please. As she moves up she clicks on the pound symbol that has her Pocket PC® say “I would like a Venti coffee please. Please leave a little room for cream.” Total time spent, one second. To Mary's dismay Starbucks® is out of both Low Fat Blueberry and Low Fat Cranberry-Orange Muffins. Fortunately Mary has the complete Starbucks® conversational groupings on her Pocket PC® minus the coffee drinks which she doesn't like. Mary clicks:

Coffee<Starbucks®>Pastry>I would like a low fat lemon scone please.

Although Mary wasn't prepared for asking for a low fat lemon scone, it takes her just four double clicks, maybe 4-6 seconds to have her device speak. After ordering Mary clicks:

Top>Mary's Workday>Morning

to display Mary's Workday Morning conversational group.

This system is easy to use and very flexible. By spending some time up front, customizing Conversational Groupings, when in the real world a user's response time is very low. By making use of the phrase distribution system, users can be download the latest menu offerings at fast food restaurants, as well as having custom phrases made for their hotel address when out of town.

Sample User Interface

FIG. 10 is an illustration of a Sample User Interface on a Cassiopeia® Portable Computer by Casio®. This is just one possible interface and is shown for illustrative purposes only. To interact with this User Interface (UI) a user pushes on a particular area on the display with a stick, which is called point and click, or click. Double clicking is clicking on the same area two consecutive times. Activating means causing a phrase to be spoken by the device.

This UI gives a user three different options to select a phrase to be spoken, icons, number code and clicking on phrases. It is designed to be easy, fast and convenient to use in any real world environments. The name of the conversational grouping that is displayed is shown at top 900. Icons are shown along the right side 901. These are activated by either double clicking on them or by single clicking to highlight, then-clicking on the # sign 902 to activate. Phrases are displayed on the left 903. These phrases are activated by either double clicking or clicking once to highlight and clicking on # to activate. The third method to select a phrase is by clicking on the numbers on the bottom of the UI 902. Digits that are clicked on are shown in the lower left box 904. When the required three digit code is shown, clicking on # activates the phrase.

Icons are used for frequently used phrases. Like every item on the UI they are user customizable. The top icon may be for the word “yes”, the money bag may be for “how much is this?”, the telephone may be for “call 911, medical emergency.” Users will choose which icons to display and what phrases to associate with those icons. As can be seen in FIG. 10 this device is small. This is a benefit in that it is easily carried and easily used out in the real world. The flip side is that there is not much display space. As can be seen in our example User Interface, there is only room for a few icons. However, a user may wish to memorize a three-digit code for additional frequently used phrases. Please see FIG. 8 for an example of this.

The remainder of the UI is for showing conversational groupings. These are phrases that are grouped according to social and/or real world situations. For example, FIG. 7, shows a custom conversational grouping a user may require in the morning. The conversational groupings shown are changed throughout the day depending upon the user's requirements.

Definitions

Windows CE®. This is a version of Microsoft®'s Windows® operating system that is optimized for hand-held computing devices.

Portable Devices or Mobile Device. This is a general term that refers to small computer devices. Although a notebook-sized computer is technically portable, as they typically weight six pounds or so, they do require a desktop or similar space to set up. For purposes of discussion, a Portable or Mobile Device, is a computing device that is smaller than a notebook-sized computer.

Handheld Device. A handheld device is a portable computing device that is larger than a pocket device and smaller than a notebook computer. Typically a handheld device has a display with a resolution of 640×480 or greater. Some handheld devices have a keyboard.

Handheld PC® is a handheld device which runs Windows CE® and contains a consistent package of integrated applications, wireless and wired connectivity options, and Win32 APIs for developers. Some examples of Handheld PC® are Husky Technology Field Explorer 21, Casio PA-2400, Sharp Mobilon TriPad PV-6000, Hewlett-Packard Jornada 820, NEC Computers Inc. MobilePro 880.

Pocket Device. A pocket device is a portable computing device that is small enough to fit into a jacket pocket.

Pocket PC® is a pocket device which runs Microsoft Windows CE®, has at least a quarter VGA display (320×240) and contains a consistent package of integrated applications, wireless and wired connectivity options, and Win32 APIs for developers. Some examples of PocketPC® are Cassio E-115, E-125, EM500, Compaq iPAQ, Hewlet Packard hp jornada 548 and 545, Symbol PPT 2700.

The foregoing description of the preferred embodiments of the invention have been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principles of the invention and its practical application to enable one skilled in the art to utilize the invention in various embodiments and with various modifications, as are suited to the particular use contemplated. It is intended that the scope of the invention be defined by the claims appended hereto, and their equivalents.

1. A method for producing customizable audio speech for use by a person wishing to use such speech to communicate with others, which comprises the steps of
a) creating a plurality of sets and sub-sets of words, phrases and sentences in text form in a source language;
b) creating a plurality of sets and sub-sets of digital speech audio files corresponding to words, phrases and sentences in one or more target languages in different voices, by recording the voices speaking the words, phrases and sentences in the one or more target languages;
c) associating each of the words, phrases and sentences in text form in the source language with one or more of the digital speech audio files, in the one or more target languages so that selection of the text form in the source language allows retrieval of the corresponding digital speech audio file in the one or more target languages in a specific voice and storing said associated sets in a central open server in digitized electronic form in a database;
d) organizing said words, phrases and sentences in text form in the source language into conversational social groups and subgroups;
e) coding said words, phrases and sentences, and said conversational social groups and subgroups to allow for rapid retrieval and for customization of same into personal groups and subgroups;
f) means for communicating requests to the central open server for additional words, phrases and sentences in text in source language to be created in additional digital audio files in one or more target languages in one or more voices; which may form part of existing or new conversational social groups and subgroups;
g) creating said additional digital audio files on a closed server for access by the requester only;
h) means for a requester to alter and create new conversational social groups and subgroups;
i) means for playing said selected digital audio speech files so that a user may use such words, phrases and sentences to communicate by speech with others in a selected target language; and
j) means for graphically displaying the one or more selected digital audio speech files to verify what is being spoken to the user.

2. A method as claimed in claim 1, wherein access to the central servers is by a workstation directly connected thereto or capable of connection through an internet connection or other suitable means.

3. A method as claimed in claim 2, wherein the workstation comprises a portable device which includes display means for displaying selected text in source language, audio playing means for playing selected digital speech audio files, and means for communicating with the central servers and/or means for playing media containing recorded test and digital speech audio files copied from the central servers.
